(19) United States
(12) Patent Application Publication
(10) Pub. No.: US 2015/0305071 A1
(43) Pub. Date: Oct. 22, 2015

(54) PUBLIC TELEPHONE DEVICE, TELEPHONE SYSTEM USING THE SAME, AND METHOD FOR DIALING PUBLIC TELEPHONE THROUGH PERSONAL WEARABLE ELECTRONIC DEVICE

(71) Applicant: SHENG-LIAN LIN, Taoyuan City (TW)

(72) Inventor: SHENG-LIAN LIN, Taoyuan City (TW)

(21) Appl. No.: 14/284,719

(22) Filed: May 22, 2014

(30) Foreign Application Priority Data
Apr. 17, 2014 (TW) 103114057

(51) Int. Cl. H04W 76/02; H04B 1/3827; H04M 1/725; H04W 4/00

(52) U.S. Cl. CPC H04W 76/021; H04W 4/008; H04B 1/3827; H04M 1/7253

(57) ABSTRACT

A public telephone device configured to connect to a communication network and be used with a personal wearable electronic device is provided. A user's identification information is set up in the personal wearable electronic device. The public telephone device includes a communication module, a control unit and a display panel, wherein the communication module and the personal wearable electronic device are configured to transmit signals with each other. The control unit is electrically connected to the communication module, and is configured to validate the user's identification information captured by the communication module via the communication network. The personal wearable electronic device can build up a voice communication through the public telephone device after a successful validation. The display panel is electrically connected to the control unit. A telephone system including the public telephone device and the personal wearable electronic device is further provided.

### FIELD OF THE INVENTION

The present invention generally relates to a telephone system and a method for dialing telephone, and more particularly to a public telephone system and a method for dialing public telephone by using a personal wearable electronic device.

### BACKGROUND OF THE INVENTION

With the popularity of cell phones, the number of public telephone device has significantly decreased.

However, with the increasing size of cell phone resulted by being equipped with increasing size of display screen and increasing number of functions, it is not convenient for a user to carry a large-sized cell phone always. Especially, for those using the cell phone for phone calls only, not only money but also resources are wasted.

### SUMMARY OF THE INVENTION

One aspect of the present invention is to provide a public telephone device configured to connect to a personal wearable electronic device and validate user's identification information to build up a voice communication.

Another aspect of the present invention is to provide a telephone system configured to establish a voice communication via a connection of a personal wearable electronic device and a public telephone device.

Still another aspect of the present invention is to provide a method for dialing a public telephone device through a personal wearable electronic device, thereby solving the problem of not easy for finding traditional public telephones.

The present invention provides a public telephone device which is configured to connect to a communication network and is used with a personal wearable electronic. The personal wearable electronic device is set up with a user's identification information therein. The public telephone device includes a communicate module, a control unit and a display panel, wherein the communication module is configured to transmit and receive a signal from the personal wearable electronic device. The control unit is electrically connected to the communication module, and configured to validate, through the communication network, the user's identification information obtained by the communication module. The personal wearable electronic device can build up a voice communication through the public telephone device when the validation of the user's identification information is positive. The display panel is electrically connected to the control unit.

In one embodiment, the display panel is a touch panel.

In one embodiment, the public telephone device is an interactive multimedia terminal (KIOSK).

In one embodiment, the signal transmitted between the communication module and the personal wearable electronic device is a Bluetooth signal.

The present invention further provides a method for dialing a public telephone device by using a personal wearable electronic device. The personal wearable electronic device is set up with a user's identification information. The method for dialing the public telephone device by using the personal wearable electronic device includes steps of: transmitting the user's identification information of the personal wearable electronic device to the public telephone device, wherein the public telephone device is connected to a communication network; validating, through the communication network, the user's identification information obtained by the public telephone device; and building up, by the personal wearable electronic device, a voice communication through the public telephone device when the validation of the user's identification information is positive.

In one embodiment, the user's identification information is subscriber identity module (SIM) card format.

In one embodiment, the personal wearable electronic device is a Bluetooth headset.

In one embodiment, the public telephone device includes a touch panel configured to display a dial keypad when the validation of the user's identification information is positive.

In one embodiment, the personal wearable electronic is further configured to, when the validation of the user's identification information is positive and before the dial keypad is displayed, display a login interface for a user to enter authentication information.

The present invention still further provides a telephone system, which includes a public telephone device and a personal wearable electronic device. The public telephone device is connected to a communication network. The public telephone includes a communication module, a control unit and a display panel. The control unit is electrically connected to the communication module and the display panel. The personal wearable electronic device is set up with a user's identification information and configured to transmit and receive a signal from the communication module, validate the user's identification information obtained by the communication module through the communication network, and build up a voice communication through the public telephone device when the validation of the user's identification information is positive.

In summary, through connecting a personal wearable electronic device to a public telephone device and validating a user's identification information set in the personal wearable electronic device via a communication network connected to the public telephone device, a user can build up a voice communication through the telephone system of the present invention. Because the public telephone device can be implemented with an interactive multimedia terminal which is commonly set in convenience stores, the problem of not easy for finding traditional public telephones is solved. Moreover, compared with the mobile phones, the personal wearable electronic device has a smaller size and accordingly it is easier and more convenient for a user to carry the personal wearable electronic device. In addition, compared with the mobile phones, the personal wearable electronic device has relatively simple functions so more power can be saved, the cost-of-production is down and the problems of resource waste is avoided. In addition, a user can perform a voice communication through the telephone system of the present invention without any coin due to the aforementioned voice communication is through a telecommunication company and the telecommunication company can record each call charge and send bills to users periodically.

Other advantages, objectives and features of the present invention will become apparent from the following description referring to the attached drawings.

### BRIEF DESCRIPTION OF THE DRAWINGS

FIG. 1 is a perspective schematic view of a telephone system according to an embodiment of the present invention;

FIG. 2 is a block view of the telephone system shown in FIG. 1; and

FIG. 3 is a flow chart of a method for dialing a public telephone through a personal wearable electronic device according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

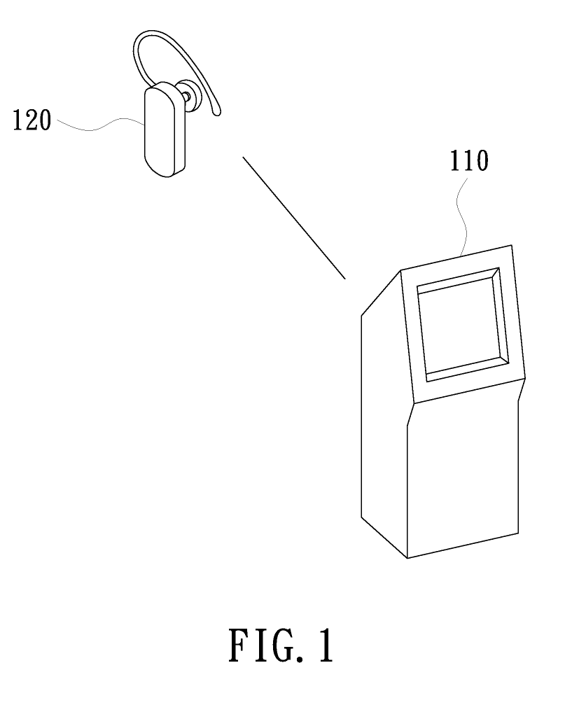

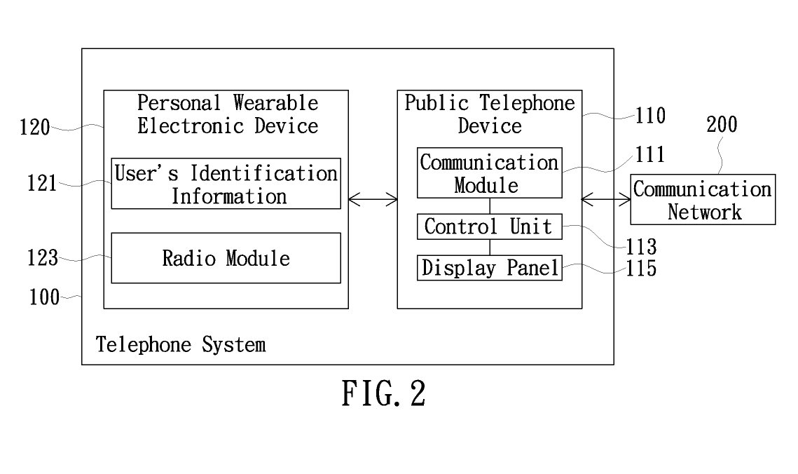

FIG. 1 is a perspective schematic view of a telephone system in accordance with an embodiment of the present invention. FIG. 2 is a block view of the telephone system of FIG. 1. Please refer to FIGS. 1 and 2. The telephone system 100 in the present embodiment includes a public telephone device 110 and a personal wearable electronic device 120. The public telephone device 110 is connected to a communication network 200 in wired or wireless manner and can be used with the personal wearable electronic device 120. The public telephone device 110 includes a communication module 111, a control unit 113 and a display panel 115. The personal wearable electronic device 120 is set up with a user's identification information 121 therein. The communication module 111 and the personal wearable electronic device 120 are configured to transmit signals with each other. The control unit 113 is electrically connected to the communication module 111 and is configured to validate, through the communication network 200, the user's identification information 121 obtained by the communication module 111. The personal wearable electronic device 120 is configured to build up a voice communication through the public telephone device 110 when the aforementioned validation of the user's identification information 121 is positive. The display panel 115 is electrically connected to the control unit 113.

In one embodiment, the public telephone device 110 may be an interactive multimedia terminal (KIOSK), such as an ibon terminal, a Life-ET terminal or a FamiPort terminal which is commonly seen in convenience stores in Taiwan or an information terminal set in public areas. In another embodiment, the public telephone device 110 may be a computer or any other types of electronic devices which is connected to the communication network 200 via a variety of connection ways.

The communication module 111 and the personal wearable electronic device 120 can transmit signals with each other via a specific way. For example, signals between the communication module 111 and the personal wearable electronic device 120 can be transmitted by way of Bluetooth; however, the present invention is not limited thereto. In addition, one or more graphical user interfaces for specific purposes may be displayed on the display panel 115 of the public telephone device 110. For example, a call interface may be displayed on the display panel 115; and accordingly a user can perform a voice communication through the public telephone device 110 by clicking the call interface. In one embodiment, a user can directly click the call interface and input specific information if the display panel 115 is a touch panel. In another embodiment, a user may need a physical keyboard or a cursor control device for clicking the call interface and inputting specific information if the display panel 115 is a non-touch panel.

In one embodiment, the personal wearable electronic device 120 may be any electronic device including a microphone and a sound output unit, such as a headset (for example, a Bluetooth headset) or a smart watch and etc. As mentioned above, the personal wearable electronic device 120 is set up with the user's identification information 121. In one embodiment, the user's identification information 121 is obtained through a registration from a telecommunication company and accordingly, for instance, the user's identification information 121 has a subscriber identity module (SIM) card format.

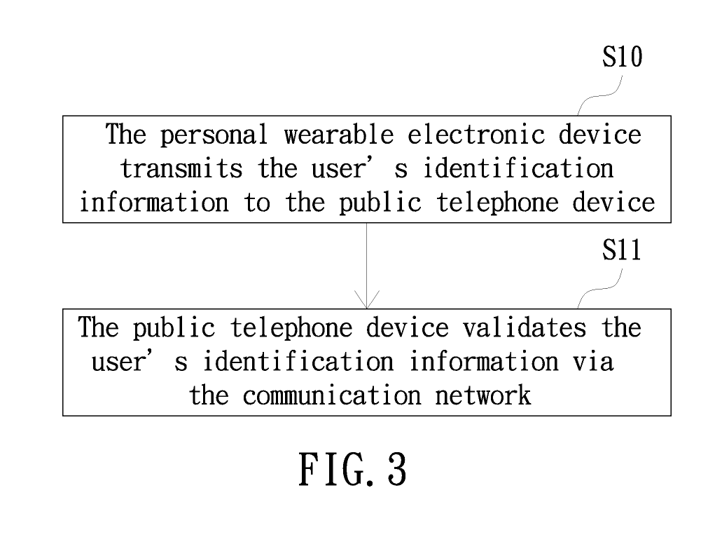

FIG. 3 is a flow chart of a method for dialing a public telephone through the personal wearable electronic device 120 in accordance with an embodiment of the present invention. Please refer to FIGS. 2 and 3. As shown, the method for dialing a public telephone through the personal wearable electronic device 120 of the present embodiment includes the following steps. First, the personal wearable electronic device 120 transmits the user's identification information 121 to the public telephone device 110 (step S10). In one embodiment, specifically, the user's identification information 121 is transmitted from the personal wearable electronic device 120 to the communication module 111 after a user clicks the call interface of the public telephone device 110 and thereby configuring the communication module 111 of the public telephone device 110 and the personal wearable electronic device 120 to be able to transmit signals with each other.

Then, the public telephone device 110 validates the user's identification information 121 via the communication network 200 (step S11). Consequentially, the personal wearable electronic device 120 can build up a voice communication through the public telephone device 110 if the aforementioned validation of the user's identification information 121 is positive. For the validation of the user's identification information 121, the control unit 113 may first controls the communication module 111 to connect, via the communication network 200, to a telecommunication company which provides the user's identification information 121 in one embodiment. If the validation of the user's identification information 121 is positive, the control unit 113 may receive a positive-validation signal from the telecommunication company through the communication module 111; and accordingly, the display panel 115 displays, through a control of the control unit 113, a dial-up interface for a user to dialup and thereby performing a voice communication through the personal wearable electronic device 120. In one embodiment, a virtual dialup keypad may be displayed on the display panel 115 if the display panel 115 is a touch panel. In another embodiment, an input device (such as a physical keyboard or a cursor control device) for a user to dial up may be provided if the display panel 115 is a non-touch panel.

For the dial fraud prevention, in one embodiment a login interface, for asking a user to enter authentication information, may be displayed on the display panel 15 before the dial up. The aforementioned authentication information may be user's ID or password, and the present invention is not limited thereto.

Alternatively, if the validation of the user's identification information 121 is negative, the control unit 113 may receive a negative-validation signal from the telecommunication company through the communication module 111; and accordingly, the display panel 115 displays specific information for indicating that the user cannot build up a voice communication through the public telephone device 120.

In one embodiment, it is noted that the personal wearable electronic device 120 may further include a radio module 123 for receiving an incoming phone call signal; and accordingly, the personal wearable electronic device 120 is further configured to issue an alert sound to remind user when the radio module 123 receives the incoming phone call signal, which indicates that there is an incoming phone call. Consequentially, the user can reply the incoming phone call by connecting the personal wearable electronic device 120 with the public telephone device 110.

In summary, through connecting a personal wearable electronic device to a public telephone device and validating a user's identification information set in the personal wearable electronic device via a communication network connected to the public telephone device, a user can build up a voice communication through the telephone system of the present invention. Because the public telephone device can be implemented with an interactive multimedia terminal which is commonly set in convenience stores, the problem of not easy for finding traditional public telephones is solved. Moreover, compared with the mobile phones, the personal wearable electronic device has a smaller size and accordingly it is easier and more convenient for a user to carry the personal wearable electronic device. In addition, compared with the mobile phones, the personal wearable electronic device has relatively simple functions so more power can be saved, the cost-of-production is down and the problems of resource waste is avoided. In addition, a user can perform a voice communication through the telephone system of the present invention without any coin due to the aforementioned voice communication is through a telecommunication company and the telecommunication company can record each call charge and send bills to users periodically.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A public telephone device configured to connect to a communication network and used with a personal wearable electronic device, the personal wearable electronic device being set up with a user's identification information therein, the public telephone device comprising:
a communication module, configured to transmit and receive a signal from the personal wearable electronic device;
a control unit, electrically connected to the communication module and configured to validate, through the communication network, the user's identification information obtained by the communication module, wherein the personal wearable electronic device builds up a voice communication through the public telephone device when the validation of the user's identification information is positive; and
a display panel, electrically connected to the control unit.

2. The public telephone device according to claim 1, wherein the display panel is a touch panel.

3. The public telephone device according to claim 1, wherein the public telephone device is an interactive multimedia terminal (KIOSK).

4. The public telephone device according to claim 1, wherein the signal transmitted between the communication module and the personal wearable electronic device is a Bluetooth signal.

5. A method for dialing a public telephone device by using a personal wearable electronic device, the personal wearable electronic device being set up with a user's identification information therein, the method comprising steps of:
transmitting the user's identification information of the personal wearable electronic device to the public telephone device, wherein the public telephone device is connected to a communication network;
validating, through the communication network, the user's identification information obtained by the public telephone device; and
building up, by the personal wearable electronic device, a voice communication through the public telephone device when the validation of the user's identification information is positive.

6. The method according to claim 5, wherein the user's identification information has a subscriber identity module (SIM) card format.

7. The method according to claim 5, wherein the personal wearable electronic device is a Bluetooth headset.

8. The method according to claim 5, wherein the personal wearable electronic device further comprises a radio module for receiving an incoming phone call signal.

9. The method according to claim 5, wherein the public telephone device comprises a touch panel configured to display a dialup keypad when the validation of the user's identification information is positive.

10. The method according to claim 9, wherein the touch panel is further configured to, when the validation of the user's identification information is positive and before the dialup keypad is displayed, display a login interface for a user to enter an authentication information.

11. A telephone system, comprising:
a public telephone device, connected to a communication network and comprising a communication module, a control unit and a display panel, wherein the control unit is electrically connected to the communication module and the display panel; and
a personal wearable electronic device, set up with a user's identification information therein, configured to transmit and receive a signal from the communication module, validate the user's identification information obtained by the communication module through the communication network, and build up a voice communication through the public telephone device when the validation of the user's identification information is positive.
